(19) United States
(12) Patent Application Publication
(10) Pub. No.: US 2025/0133488 A1
(43) Pub. Date: Apr. 24, 2025

(54) TECHNIQUES FOR NETWORK SLICE SPECIFIC CELL SELECTION

(71) Applicant: QUALCOMM Incorporated, San Diego, CA (US)

(72) Inventors: Jianhua LIU, Beijing (CN); Ozcan OZTURK, San Diego, CA (US); Peng CHENG, Beijing (CN); Miguel GRIOT, La Jolla, CA (US); Xipeng ZHU, San Diego, CA (US)

(21) Appl. No.: 18/694,393

(22) PCT Filed: Dec. 1, 2021
(86) PCT No.: PCT/CN2021/134788

§ 371 Date: Mar. 21, 2024

(51) Int. Cl. H04W 48/18

(52) U.S. Cl. CPC H04W 48/18

(57) ABSTRACT

Various aspects of the present disclosure generally relate to wireless communication. In some aspects, a user equipment (UE) may receive information identifying a set of network slice specific cell selection evaluation parameters, wherein the set of network slice specific cell selection evaluation parameters include one or more parameter values associated with a characteristic of a type of cell selection that is to be performed. The UE may perform the type of cell selection in accordance with the set of network slice specific cell selection evaluation parameters. Numerous other aspects are described.

### FIELD OF THE DISCLOSURE

Aspects of the present disclosure generally relate to wireless communication and to techniques and apparatuses for network slice specific cell selection.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving information identifying a set of network slice specific cell selection evaluation parameters, wherein the set of network slice specific cell selection evaluation parameters include one or more parameter values associated with a characteristic of a type of cell selection that is to be performed. The method may include performing the type of cell selection in accordance with the set of network slice specific cell selection evaluation parameters.

Some aspects described herein relate to a method of wireless communication performed by a base station. The method may include transmitting, to a UE, information identifying a set of network slice specific cell selection evaluation parameters, wherein the set of network slice specific cell selection evaluation parameters include one or more parameter values associated with a characteristic of a type of cell selection that is to be performed. The method may include communicating with the UE on a cell selected in accordance with a cell selection and the set of network slice specific cell selection evaluation parameters.

Some aspects described herein relate to a UE for wireless communication. The UE may include a memory and one or more processors coupled to the memory. The one or more processors may be configured to receive information identifying a set of network slice specific cell selection evaluation parameters, wherein the set of network slice specific cell selection evaluation parameters include one or more parameter values associated with a characteristic of a type of cell selection that is to be performed. The one or more processors may be configured to perform the type of cell selection in accordance with the set of network slice specific cell selection evaluation parameters.

Some aspects described herein relate to a base station for wireless communication. The base station may include a memory and one or more processors coupled to the memory. The one or more processors may be configured to transmit, to a UE, information identifying a set of network slice specific cell selection evaluation parameters, wherein the set of network slice specific cell selection evaluation parameters include one or more parameter values associated with a characteristic of a type of cell selection that is to be performed. The one or more processors may be configured to communicate with the UE on a cell selected in accordance with a cell selection and the set of network slice specific cell selection evaluation parameters.

Some aspects described herein relate to a non-transitory computer-readable medium that stores a set of instructions for wireless communication by a UE. The set of instructions, when executed by one or more processors of the UE, may cause the UE to receive information identifying a set of network slice specific cell selection evaluation parameters, wherein the set of network slice specific cell selection evaluation parameters include one or more parameter values associated with a characteristic of a type of cell selection that is to be performed. The set of instructions, when executed by one or more processors of the UE, may cause the UE to perform the type of cell selection in accordance with the set of network slice specific cell selection evaluation parameters.

Some aspects described herein relate to a non-transitory computer-readable medium that stores a set of instructions for wireless communication by a base station. The set of instructions, when executed by one or more processors of the base station, may cause the base station to transmit, to a UE, information identifying a set of network slice specific cell selection evaluation parameters, wherein the set of network slice specific cell selection evaluation parameters include one or more parameter values associated with a characteristic of a type of cell selection that is to be performed. The set of instructions, when executed by one or more processors of the base station, may cause the base station to communicate with the UE on a cell selected in accordance with a cell selection and the set of network slice specific cell selection evaluation parameters.

Some aspects described herein relate to an apparatus for wireless communication. The apparatus may include means for receiving information identifying a set of network slice specific cell selection evaluation parameters, wherein the set of network slice specific cell selection evaluation parameters include one or more parameter values associated with a characteristic of a type of cell selection that is to be performed. The apparatus may include means for performing the type of cell selection in accordance with the set of network slice specific cell selection evaluation parameters.

Some aspects described herein relate to an apparatus for wireless communication. The apparatus may include means for transmitting, to a UE, information identifying a set of network slice specific cell selection evaluation parameters, wherein the set of network slice specific cell selection evaluation parameters include one or more parameter values associated with a characteristic of a type of cell selection that is to be performed. The apparatus may include means for communicating with the UE on a cell selected in accordance with a cell selection and the set of network slice specific cell selection evaluation parameters.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3A and 3B are diagrams illustrating examples of cell selection, in accordance with the present disclosure.

FIGS. 4A-4E are diagrams illustrating examples associated with network slice specific cell selection, in accordance with the present disclosure.

FIGS. 5-6 are diagrams illustrating example processes associated with network slice specific cell selection, in accordance with the present disclosure.

FIGS. 7-8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

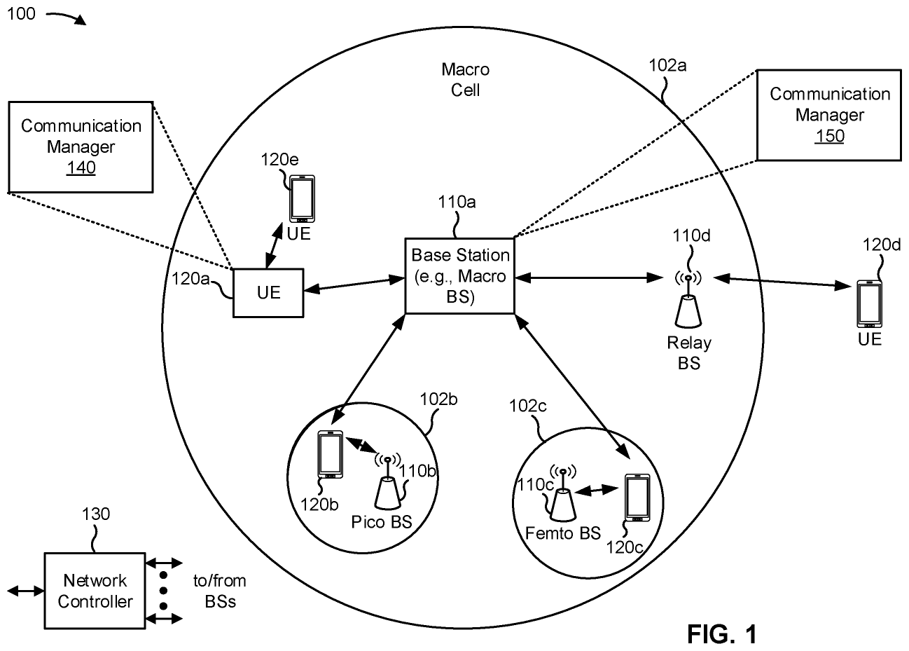

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive information identifying a set of network slice specific cell selection evaluation parameters, wherein the set of network slice specific cell selection evaluation parameters include one or more parameter values associated with a characteristic of a type of cell selection that is to be performed; and perform the type of cell selection in accordance with the set of network slice specific cell selection evaluation parameters. Additionally, or alternatively, the communication manager 140 may perform one or more other operations described herein.

In some aspects, the base station 110 may include a communication manager 150. As described in more detail elsewhere herein, the communication manager 150 may transmit, to a UE, information identifying a set of network slice specific cell selection evaluation parameters, wherein the set of network slice specific cell selection evaluation parameters include one or more parameter values associated with a characteristic of a type of cell selection that is to be performed; and communicate with the UE on a cell selected in accordance with a cell selection and the set of network slice specific cell selection evaluation parameters. Additionally, or alternatively, the communication manager 150 may perform one or more other operations described herein.

As indicated above, FIG. 1 is provided as an example. Other examples may differ from what is described with regard to FIG. 1.

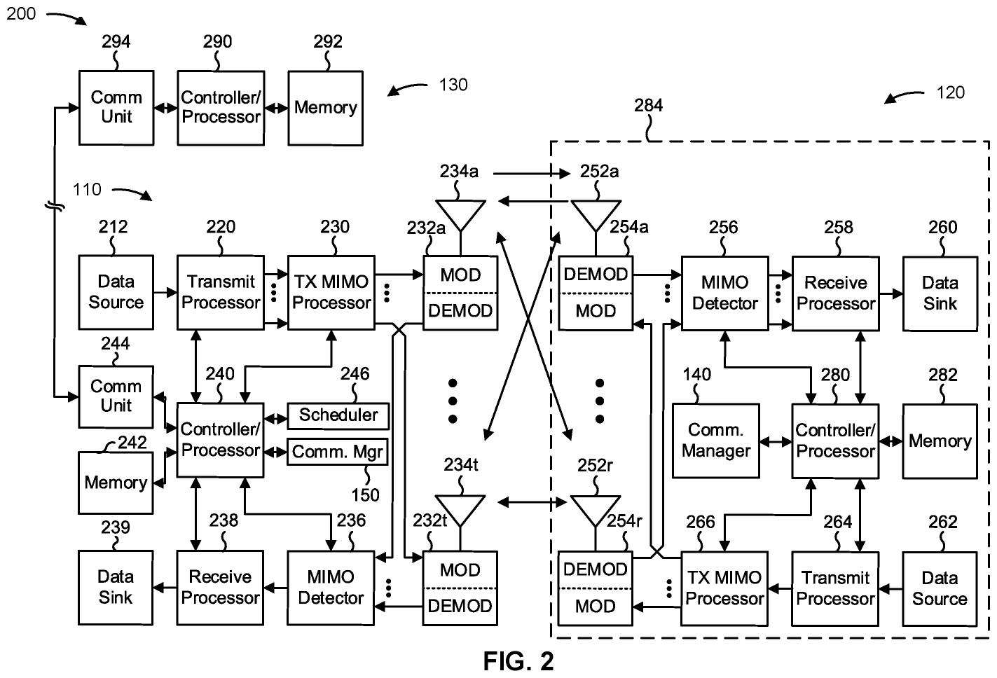

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

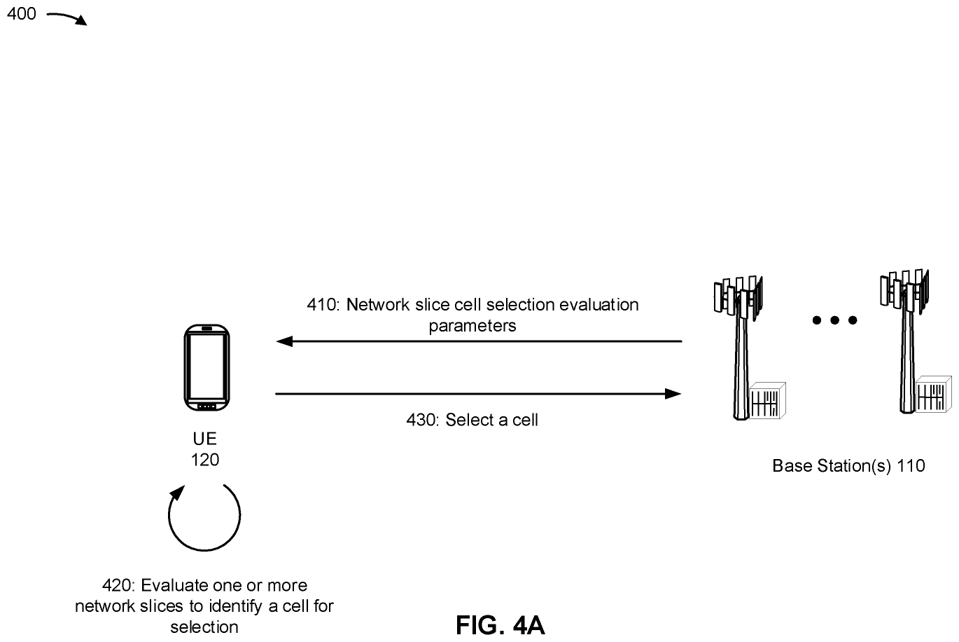

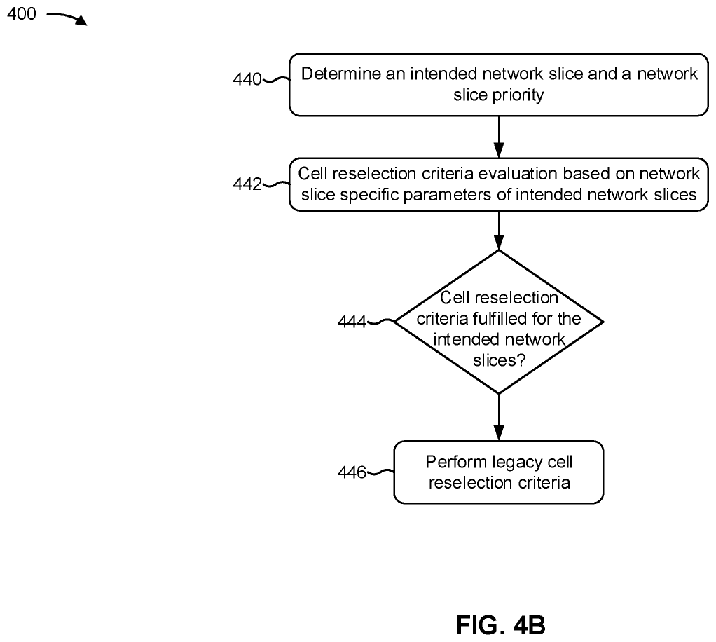

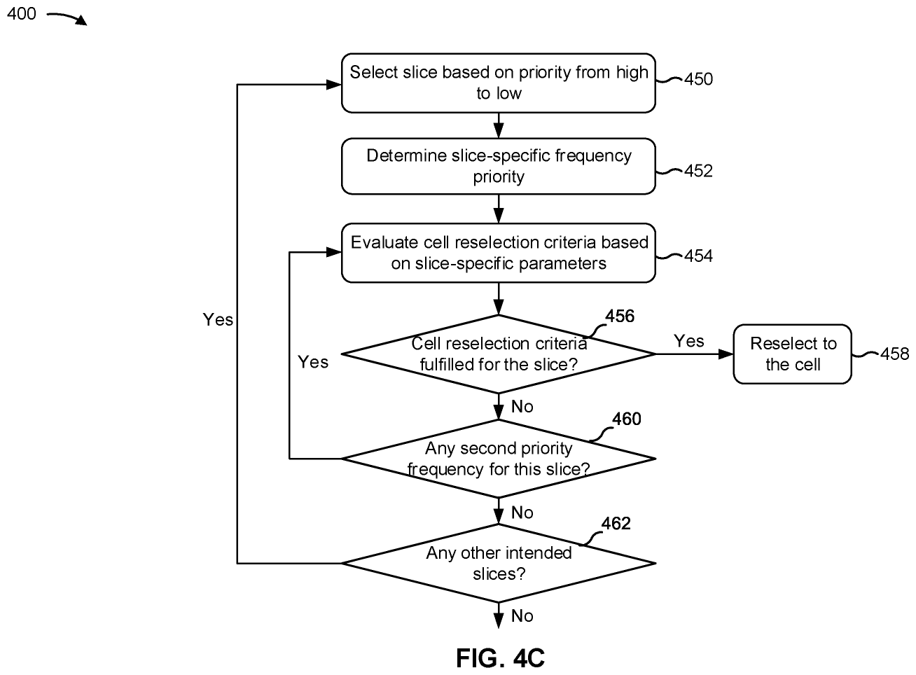

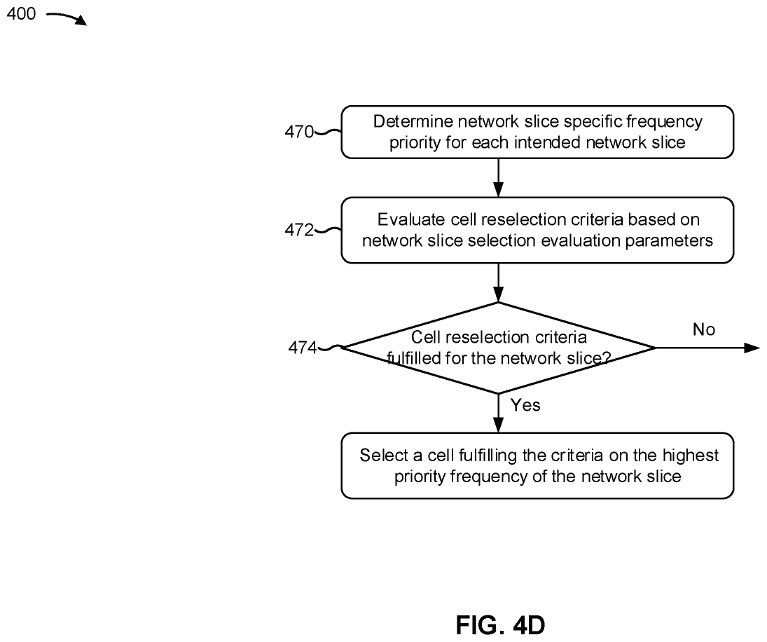

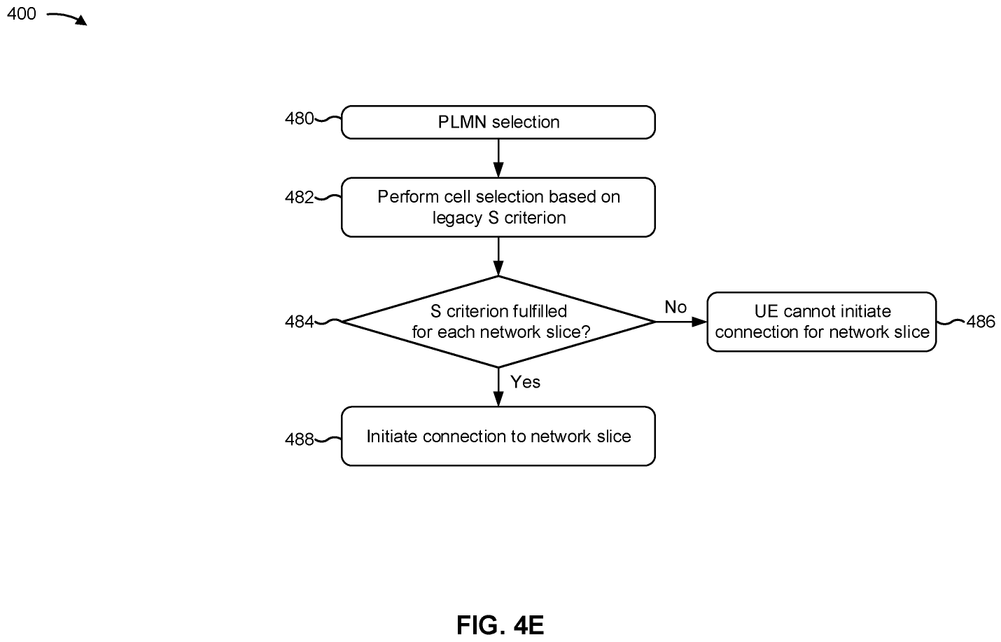

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4A-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4A-8).

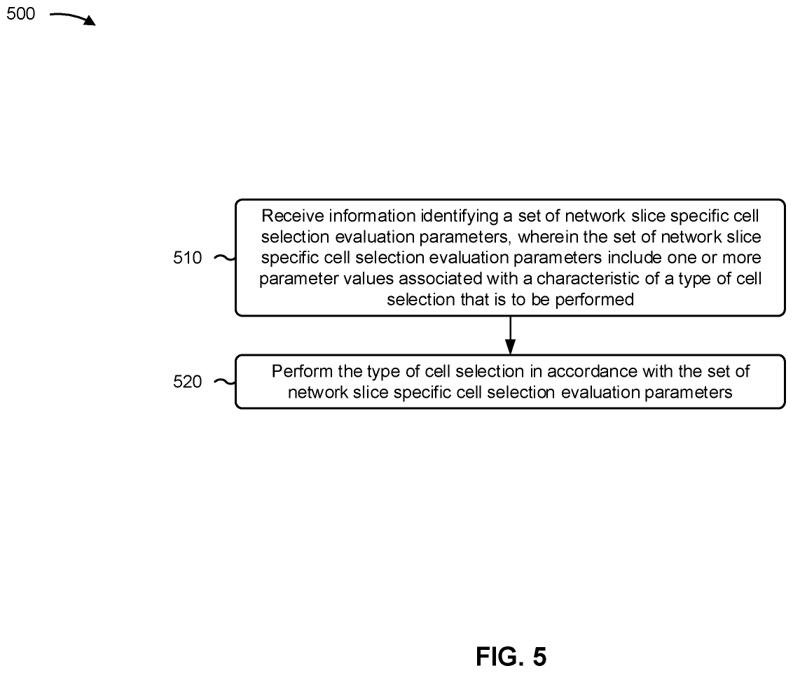

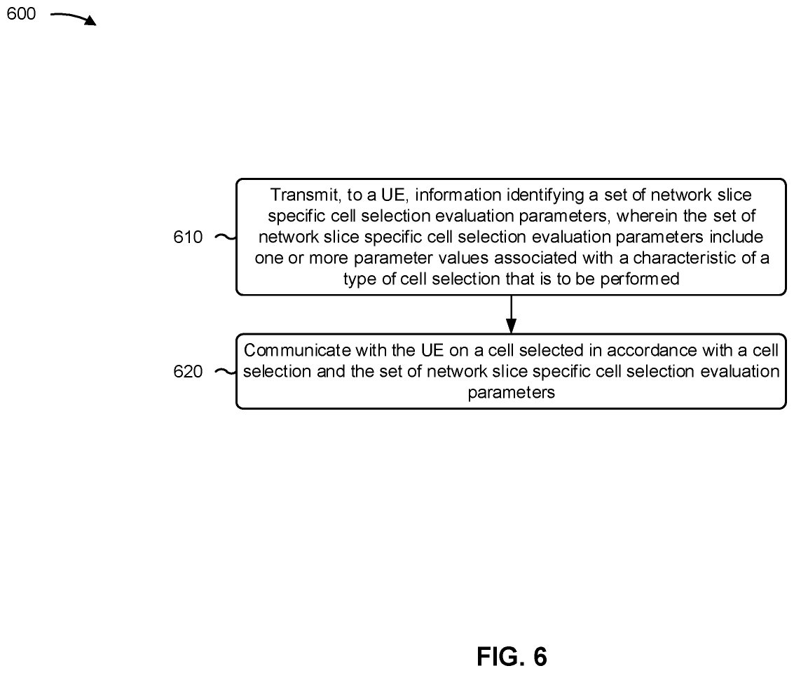

The controller/processor 240 of the base station 110, the controller/processor 280 of the UE 120, and/or any other component(s) of FIG. 2 may perform one or more techniques associated with network slice specific cell selection, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the UE 120 includes means for receiving information identifying a set of network slice specific cell selection evaluation parameters, wherein the set of network slice specific cell selection evaluation parameters include one or more parameter values associated with a characteristic of a type of cell selection that is to be performed; and/or means for performing the type of cell selection in accordance with the set of network slice specific cell selection evaluation parameters. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE, information identifying a set of network slice specific cell selection evaluation parameters, wherein the set of network slice specific cell selection evaluation parameters include one or more parameter values associated with a characteristic of a type of cell selection that is to be performed; and/or means for communicating with the UE on a cell selected in accordance with a cell selection and the set of network slice specific cell selection evaluation parameters. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

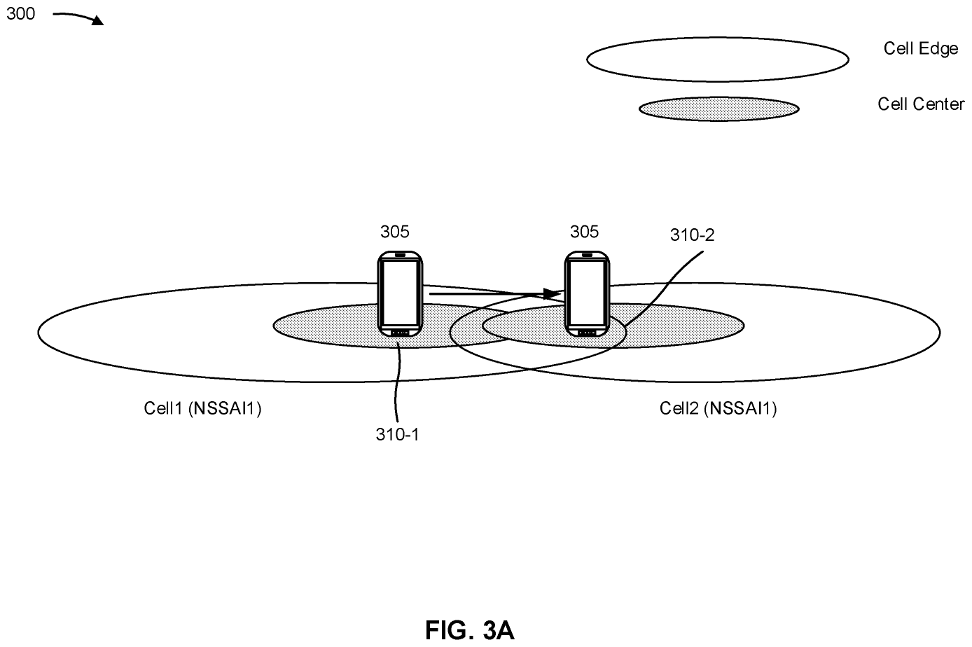

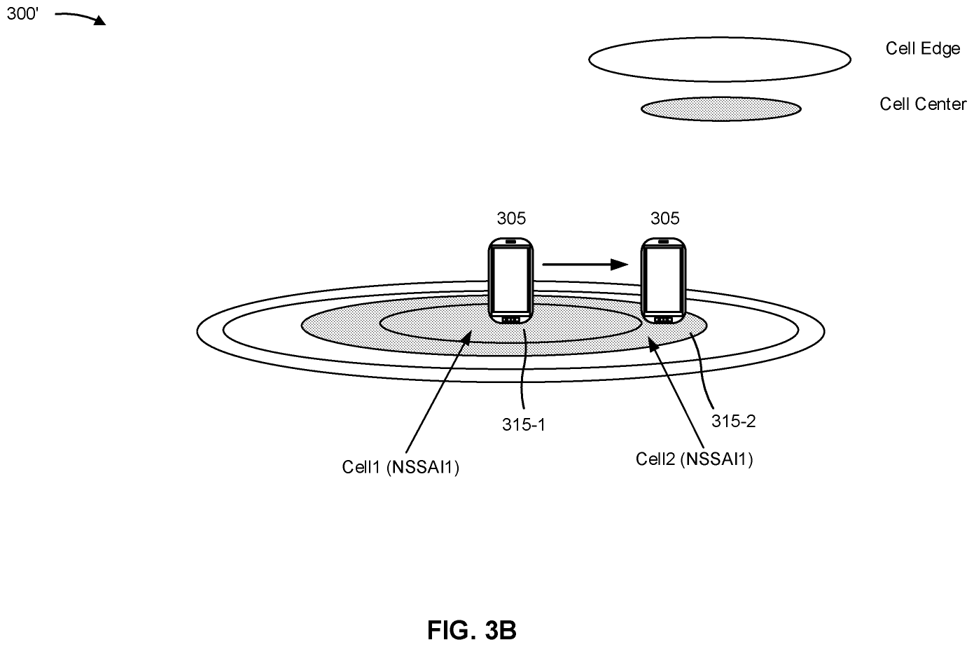

FIG. 3A and 3B are diagrams illustrating examples 300/300′ of cell selection, in accordance with the present disclosure.

As shown in FIGS. 3A and 3B, a UE 305 may be located within a coverage area that includes a first cell (Cell1) and a second cell (Cell2). The first cell and the second cell may have the same priority level. In example 300 of FIG. 3A, the first cell and the second cell may be partially overlapping, such that cell edges and/or at least a portion of a cell center overlap. In contrast, in example 300′ of FIG. 3B, the first cell may be located within the second cell, such that cell edges of the second cell enclose cell edges of the first cell and a cell center of the second cell encloses a cell center of the first cell. Both Cell1 and Cell2 may have support for the same network slice selection assistance information (NSSAI) value (NSSAI1) within respective cell centers of the first cell and the second cell (e.g., areas where radio quality satisfies a threshold).

As shown in FIG. 3A, when UE 305 moves from a first location 310-1 in the first cell to a second location 310-2 in the second cell, UE 305 may perform a cell reselection procedure (e.g., a type of cell selection for a UE already using a cell) to attempt to reselect from the first cell to the second cell. However, based at least in part on cell reselection criteria of the cell reselection procedure, UE 305 may lose coverage when moving from the first cell to the second cell. Moreover, at location 310-2, UE 305 may not initiate call setup.

Similarly, as shown in FIG. 3B, when UE 305 moves from a first location 315-1 in the first cell to a second location 315-2 in the second cell, UE 305 may not perform call setup as a result of having left the cell center where NSSAI1 is supported. Moreover, at location 315-2, UE 305 may lose coverage for an intended network slice. When UE 305 is unable to find a suitable cell for an intended network slice, UE 305 may not be able to fall back to a non network slice based cell selection procedure.

As indicated above, FIGS. 3A and 3B are provided as one or more examples. Other examples may differ from what is described with respect to FIGS. 3A and 3B.

Some aspects described herein enable network slice specific cell selection procedures. For example, a UE may perform a network slice specific cell selection or reselection (e.g., which may be a type of cell selection) by using network slice specific cell selection evaluation parameters with values associated with a network slice that the UE is evaluating. For example, the UE may use an offset value or threshold value, with the value being specific to the network slice being evaluated, for evaluating a measurement of a network slice and determining whether to select the network slice and an associated cell. In this way, the UE may enable different coverage deployments for different network slices within one or more cells, thereby improving network flexibility, reducing a likelihood of a failure to initiate call setup, reducing a likelihood of a loss of coverage, or reducing a likelihood of interrupted or poor communications.

FIGS. 4A-4E are diagrams illustrating an example 400 associated with network slice specific cell selection, in accordance with the present disclosure. As shown in FIG. 4A, example 400 includes communication between one or more base stations 110 and a UE 120. In some aspects, the one or more base stations 110 and UE 120 may be included in a wireless network, such as wireless network 100. As shown in FIGS. 4B-4E, one or more different procedures may be used to perform network slice specific cell selection.

As further shown in FIG. 4A, and by reference number 410, UE 120 may receive information identifying a set of network slice specific cell selection evaluation parameters. For example, UE 120 may receive signaling, from base station 110, identifying the set of network slice specific cell selection evaluation parameters for use in evaluating a cell reselection or a cell selection. In some aspects, UE 120 may receive the signaling via dedicated radio resource control (RRC) signaling or a system information block (SIB) message. Additionally, or alternatively, UE 120 may obtain one or more of the set of network slice specific cell selection evaluation parameters from a memory of UE 120. For example, a network slice specific cell selection evaluation parameter may be statically defined for UE 120 in a specification and stored in a memory of UE 120. In some aspects, UE 120 may receive multiple sets of parameters from the base station 110. For example, base station 110 may provide information identifying a first set of parameters for a first type of cell selection (e.g., a legacy type of cell selection) and a second set of parameters for a second type of cell selection (e.g., a non-legacy type of cell selection for a network-identified subset of network slices). In some aspects, the network slice specific cell selection evaluation parameters may be associated with a network slice associated with a network slice selection assistance information identifier (NSSAI) value, a single-NSSAI (S-NSSAI) value, a slice or service type (SST) value, or an S-NSSAI group value.

In some aspects, UE 120 may receive information identifying a particular type of network slice specific cell selection evaluation parameter (e.g., a network slice specific offset value or a network slice specific threshold value) and/or an indication of a type of cell reselection evaluation to which a network slice specific cell selection evaluation parameter applies. For example, for an evaluation relating to a cell reselection intra-frequency measurement (e.g., whether Srxlev>S_{IntraSearchP} or whether Squal>S_{IntraSearchQ}), UE 120 may be configured with a network slice specific offset, a network slice specific value for S_{IntraSearchP}, or a network slice specific value for S_{IntraSearchQ}. Similarly, for an evaluation relating to a cell reselection to a cell on a higher priority NR frequency or inter-RAT frequency (e.g., whether Squal>Thresh_{X,_HighQ} or whether Srxlev>Thresh_{X_HighQ}), UE 120 may be configured with a network slice specific offset, a network slice specific value for Thresh_{X,_HighQ}, or a network slice specific value for Thresh_{X_HighP}. Similarly, for an evaluation relating to a cell reselection to a cell on a lower priority NR frequency or inter-RAT frequency (e.g., whether Squal<Thresh_{Serving_LowQ} or Squal>Thresh_{X,_LowQ} or whether Srxlev<Thresh_{XServing_LowP} or Srxlev>Thresh_{X_LowP}), UE 120 may be configured with a network slice specific offset, a network slice specific value for Thresh_{Serving,_LowQ} or Thresh_{x_LowQ}, or a network slice specific value for Thresh_{Serving_LowP} or Thresh_{X_LowP}. Similarly, for an evaluation relating to an intra-frequency or equal priority inter-frequency cell reselection (e.g., whether Rₛ=Q_{meas,s}+Q_{hyst}−Qoffsetₜₑₘₚ or whether Rₙ=Q_{meas,n}−Q_{offset}−Qoffsetₜₑₘₚ), UE 120 may be configured with a network slice specific offset for Rₛ or Rₙ. Additionally, or alternatively, for a cell selection evaluation (e.g., whether Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ or whether Squal=Q_{qualmeas}−(Q_{qualmin}+Q_{qualminoffset})−Qoffsetₜₑₘₚ), UE 120 may be configured with a network slice specific offset to Srxlev or Squal or a network slice specific value for Qᵣₓₗₑᵥₘᵢₙ or Q_{qualmin}.

As further shown in FIG. 4A, and by reference numbers 420 and 430, UE 120 may evaluate one or more network slices to identify a cell for selection and may select the cell. For example, UE 120 may perform a cell selection procedure or a cell reselection procedure using network slice specific cell selection evaluation parameters.

As an example of a slice specific cell reselection procedure, as shown in FIG. 4B, and at block 440, UE 120 may determine an intended network slice and network slice priority. For example, UE 120 may identify a set of network slices that are indicated for the UE 120 to attempt to reselect to, and may order the set of network slices based at least in part on respective network slice priorities. In this way, UE 120 can attempt to reselect to the set of network slices in order of network slice priority before attempting to reselect to other available network slices and associated cells (e.g., not included in a set of intended network slices). In some aspects, UE 120 may determine the set of intended network slices based at least in part on a network slice indicator. For example, UE 120 may identify the set of intended network slices as one or more network slices identified by an allowed NSSAI, an allowed NSSAI group, a configured NSSAI, a configured NSSAI group, an allowed SST, or a configured SST.

As shown at block 442, UE 120 may perform an evaluation of cell reselection criteria using network slice specific cell selection evaluation parameters relating to the intended network slice with the identified network slice priority. For example, UE 120 may attempt to perform cell reselection by performing one or more of the aforementioned evaluations using one or more of the aforementioned network slice specific cell selection evaluation parameters for an intended network slice. In this case, UE 120 may perform the cell reselection criteria evaluation for intended network slices in order of respective network slice priorities, as described in more detail herein with regard to FIGS. 4C and 4D. Additionally, or alternatively, in a cell selection case, UE 120 may perform an evaluation of cell selection criteria using the network slice specific selection evaluation parameters relating to the intended network slice with the identified network slice priority. In this case, a non-access stratum (NAS) layer and associated NAS entity of UE 120 may forward network slicing information with a selected public land mobile network (PLMN) to an access stratum (AS) layer and associated AS entity to enable the AS entity of UE 120 to perform the cell selection procedure.

As shown at blocks 444 and 446, UE 120 may determine whether cell reselection criteria are fulfilled for an intended network slice and, if not, fall back to another cell reselection procedure (e.g., a non network slice specific cell reselection procedure) using non network slice specific cell reselection criteria. For example, UE 120 may determine that the cell reselection criteria are not satisfied by results of one or more measurements of the intended network slices, and may fall back to a legacy cell reselection procedure. Alternatively, UE 120 may determine that the cell reselection criteria are satisfied, as described in more detail herein with regard to FIGS. 4C and 4D.

Additionally, or alternatively, in a cell selection case, UE 120 may determine whether cell selection criteria are fulfilled for an intended network slice. For example, UE 120 may prioritize a cell, to search and/or camp onto, that fulfills the cell selection criteria for the intended network slice. In this case, UE 120 may use a network slice specific S-criterion to search a suitable cell and, if no suitable cell is found on an intended network slice using the network slice specific S-criterion, UE 120 may fall back to using a non network slice specific (e.g., legacy) S-criterion for evaluating cells of a network slice.

As an example of evaluating cell reselection criteria as shown in FIG. 4C, and as shown at 450, UE 120 may select a network slice based at least in part on a network slice priority. For example, UE 120 may select network slices in an order of network slice priority to evaluate whether to reselect onto the network slices. As shown as shown at 452, UE 120 may determine a network slice specific frequency priority. For example, UE 120 may determine the network slice specific frequency priority for a frequency of a selected network slice. As shown at 454, UE 120 may evaluate cell reselection criteria based at least in part on network slice selection evaluation parameters. For example, UE 120 may perform one or more of the aforementioned cell selection evaluations using one or more of the aforementioned network slice selection evaluation parameters specific to the network slice and the network slice specific frequency priority.

As shown at 456, UE 120 may determine whether cell reselection criteria are fulfilled for the network slice. For example, UE 120 may determine that the cell reselection criteria, using the network slice selection evaluation parameters specific to the network slice, are satisfied and may reselect to a cell associated with the network slice, as shown at 458. Alternatively, UE 120 may determine that the cell reselection criteria, using the network slice selection evaluation parameters specific to the network slice, are not satisfied and may determine whether another frequency priority is available for the network slice, as shown at 460. In this case, if another frequency priority is available, UE 120 may perform another evaluation of cell reselection criteria using the other frequency priority (e.g., until all available frequency priorities for the network slice are exhausted or until cell reselection criteria are fulfilled, as shown at 454, 456, 458, and 460).

When another frequency priority is not available, UE 120 may determine whether another network slice is included in the set of intended network slices (e.g., with a lower priority than the current network slice being evaluated), as shown at 462. For example, UE 120 may determine that the set of intended network slices includes another network slice that has not been evaluated and may select the other network slice from the set of intended network slices based at least in part on a network slice priority (e.g., in a priority order), as shown at 450. Alternatively, when another network slice is not included in the network slices, UE 120 may determine that cell reselection criteria are not fulfilled for any of the intended network slices and fall back to a legacy cell reselection procedure, as shown in FIG. 4B and at 444 and 446.

As another example of evaluating cell reselection criteria as shown in FIG. 4D, and at 470, UE 120 may determine a network slice specific frequency priority. For example, UE 120 may determine the network slice specific frequency priority for a frequency of each network slice of a set of intended network slices. As shown at 472, UE 120 may evaluate cell reselection criteria based at least in part on network slice selection evaluation parameters. For example, UE 120 may perform one or more of the aforementioned cell selection evaluations using one or more of the aforementioned network slice selection evaluation parameters specific to each network slice with each frequency priority.

As shown at 474, UE 120 may determine whether cell reselection criteria are fulfilled for any network slice. For example, UE 120 may determine that the cell reselection criteria, using the network slice selection evaluation parameters specific to the network slice, are satisfied for at least one network slice of the set of intended network slices and may reselect to a cell associated with the at least one network slice. In this case, UE 120 may select a cell that fulfills the cell reselection criteria and with a highest frequency priority for a corresponding network slice, as shown at 476. In other words, UE 120 may identify a first network slice with a first network slice priority and with multiple cells associated with multiple frequency priorities and a second network slice with a second network slice priority and multiple cells with multiple frequency priorities. In this case, UE 120 may select a cell from a lower priority network slice, providing the cell has a higher frequency priority than other cells of both the first network slice and the second network slice (and provided that the cell satisfies the cell reselection criteria).

As an example of evaluating cell selection criteria as shown in FIG. 4E, at 480, UE 120 may select a PLMN. For example, UE 120 may determine that UE 120 is to attempt to search and camp on to a cell of a PLMN. As shown at 482, UE 120 may perform cell selection using a legacy S-criterion. For example, rather than use a network slice specific S-criterion, UE 120 may use a legacy S-criterion for cell selection and, when UE 120 initiates a service call for an intended network slice, UE 120 may evaluate whether a coverage of a cell of the intended network slice satisfies one or more cell selection criteria, as shown at 484. In this case, UE 120 may use a network slice specific evaluation cell selection evaluation parameter for determining whether the coverage of the cell satisfies the one or more cell selection criteria. As shown at 486, if the one or more cell selection criteria are not satisfied, UE 120 may determine not to initiate a connection for the network slice (and may attempt to select a different network slice). Alternatively, as shown at 488, if the one or more cell selection criteria are satisfied, UE 120 may initiate a connection to the network slice.

As indicated above, FIGS. 4A-4E are provided as examples. Other examples may differ from what is described with respect to FIGS. 4A-4E.

FIG. 5 is a diagram illustrating an example process 500 performed, for example, by a UE, in accordance with the present disclosure. Example process 500 is an example where the UE (e.g., UE 120) performs operations associated with network slice specific cell selection.

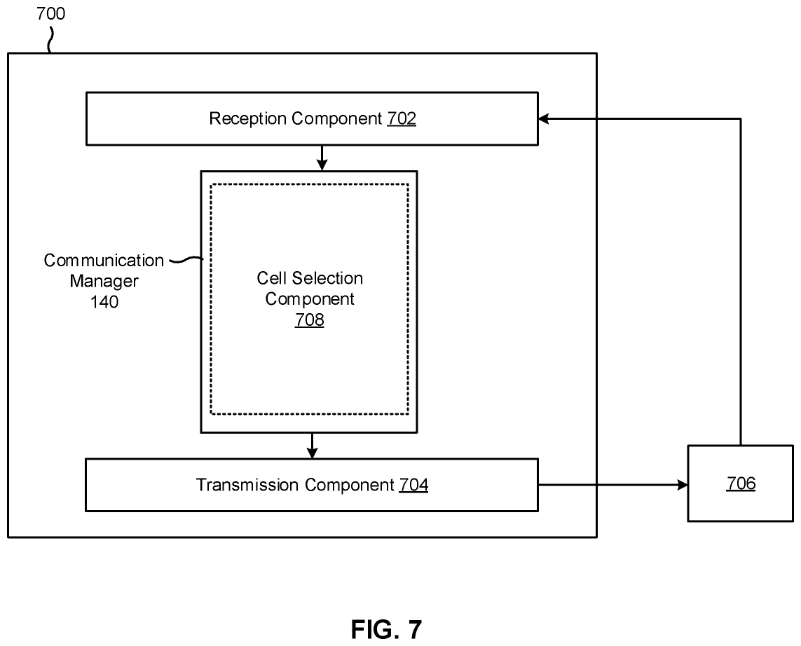

As shown in FIG. 5, in some aspects, process 500 may include receiving information identifying a set of network slice specific cell selection evaluation parameters, wherein the set of network slice specific cell selection evaluation parameters include one or more parameter values associated with a characteristic of a type of cell selection that is to be performed (block 510). For example, the UE (e.g., using communication manager 140 and/or reception component 702, depicted in FIG. 7) may receive information identifying a set of network slice specific cell selection evaluation parameters, wherein the set of network slice specific cell selection evaluation parameters include one or more parameter values associated with a characteristic of a type of cell selection that is to be performed, as described above.

As further shown in FIG. 5, in some aspects, process 500 may include performing the type of cell selection in accordance with the set of network slice specific cell selection evaluation parameters (block 520). For example, the UE (e.g., using communication manager 140 and/or cell selection component 708, depicted in FIG. 7) may perform the type of cell selection in accordance with the set of network slice specific cell selection evaluation parameters, as described above.

Process 500 may include additional aspects, such as any single aspect or any combination of aspects described below and/or in connection with one or more other processes described elsewhere herein.

In a first aspect, the cell selection is a cell reselection type of cell selection procedure or a non-cell reselection type of cell selection procedure.

In a second aspect, alone or in combination with the first aspect, the set of network slice specific cell selection evaluation parameters includes a parameter relating to at least one of an intra-frequency reselection, an inter-frequency reselection, an intra-RAT reselection, an inter-RAT reselection, or a cell priority.

In a third aspect, alone or in combination with one or more of the first and second aspects, the set of network slice specific cell selection evaluation parameters includes a value for at least one of a network slice offset or a network slice threshold.

In a fourth aspect, alone or in combination with one or more of the first through third aspects, the set of network slice specific cell selection evaluation parameters relate to a network slice associated with at least one of a network slice selection assistance information identifier, a single network slice selection assistance information identifier, a single network slice selection assistance information identifier group, or a slice or service type identifier.

In a fifth aspect, alone or in combination with one or more of the first through fourth aspects, the information identifying the set of network slice specific cell selection evaluation parameters is received via a dedicated radio resource control message, a system information block message, or a subscription establishment message.

In a sixth aspect, alone or in combination with one or more of the first through fifth aspects, the information identifying the set of network slice specific cell selection evaluation parameters is received from a memory.

In a seventh aspect, alone or in combination with one or more of the first through sixth aspects, the cell selection is based at least in part on a network slice to which the set of network slice specific cell selection evaluation parameters applies.

In an eighth aspect, alone or in combination with one or more of the first through seventh aspects, the set of network slice specific cell selection evaluation parameters includes a plurality of subsets of parameters applicable to a plurality of different types of use cases.

In a ninth aspect, alone or in combination with one or more of the first through eighth aspects, the cell selection includes an evaluation of one or more slices.

In a tenth aspect, alone or in combination with one or more of the first through ninth aspects, the cell selection includes an evaluation of a slice priority of a plurality of slices associated with a particular frequency.

In an eleventh aspect, alone or in combination with one or more of the first through tenth aspects, the cell selection is initiated based at least in part on an evaluation of a criterion relating to initiating a call connection.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 110) performs operations associated with network slice specific cell selection.

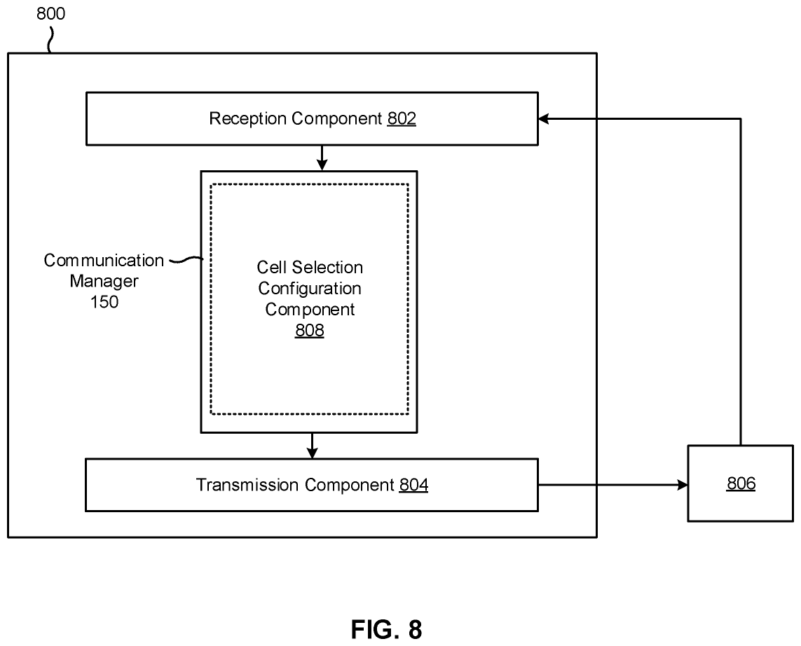

As shown in FIG. 6, in some aspects, process 600 may include transmitting, to a UE, information identifying a set of network slice specific cell selection evaluation parameters, wherein the set of network slice specific cell selection evaluation parameters include one or more parameter values associated with a characteristic of a type of cell selection that is to be performed (block 610). For example, the base station (e.g., using communication manager 150 and/or transmission component 804, depicted in FIG. 8) may transmit, to a UE, information identifying a set of network slice specific cell selection evaluation parameters, wherein the set of network slice specific cell selection evaluation parameters include one or more parameter values associated with a characteristic of a type of cell selection that is to be performed, as described above.

As further shown in FIG. 6, in some aspects, process 600 may include communicating with the UE on a cell selected in accordance with a cell selection and the set of network slice specific cell selection evaluation parameters (block 620). For example, the base station (e.g., using communication manager 150 and/or reception component 802 and/or transmission component 804, depicted in FIG. 8) may communicate with the UE on a cell selected in accordance with a cell selection and the set of network slice specific cell selection evaluation parameters, as described above.

Process 600 may include additional aspects, such as any single aspect or any combination of aspects described below and/or in connection with one or more other processes described elsewhere herein.

In a first aspect, the cell selection is a cell reselection type of cell selection procedure or a non-cell reselection type of cell selection procedure.

In a second aspect, alone or in combination with the first aspect, the set of network slice specific cell selection evaluation parameters includes a parameter relating to at least one of an intra-frequency reselection, an inter-frequency reselection, an intra-RAT reselection, an inter-RAT reselection, or a cell priority.

In a third aspect, alone or in combination with one or more of the first and second aspects, the set of network slice specific cell selection evaluation parameters includes a value for at least one of a network slice offset or a network slice threshold.

In a fourth aspect, alone or in combination with one or more of the first through third aspects, the set of network slice specific cell selection evaluation parameters relate to a network slice associated with at least one of a network slice selection assistance information identifier, a single network slice selection assistance information identifier, a single network slice selection assistance information identifier group, or a slice or service type identifier.

In a fifth aspect, alone or in combination with one or more of the first through fourth aspects, the information identifying the set of network slice specific cell selection evaluation parameters is transmitted via a dedicated radio resource control message, a system information block message, or a subscription establishment message.

In a sixth aspect, alone or in combination with one or more of the first through fifth aspects, the cell selection is based at least in part on a network slice to which the set of network slice specific cell selection evaluation parameters applies.

In a seventh aspect, alone or in combination with one or more of the first through sixth aspects, the set of network slice specific cell selection evaluation parameters includes a plurality of subsets of parameters applicable to a plurality of different types of use cases.

In an eighth aspect, alone or in combination with one or more of the first through seventh aspects, the cell selection includes an evaluation of one or more slices.

In a ninth aspect, alone or in combination with one or more of the first through eighth aspects, the cell selection includes an evaluation of a slice priority of a plurality of slices associated with a particular frequency.

In a tenth aspect, alone or in combination with one or more of the first through ninth aspects, the cell selection is initiated based at least in part on an evaluation of a criterion relating to initiating a call connection.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include a cell selection component 708, among other examples.

In some aspects, the apparatus 700 may be configured to perform one or more operations described herein in connection with FIGS. 4A-4E. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The reception component 702 may receive information identifying a set of network slice specific cell selection evaluation parameters, wherein the set of network slice specific cell selection evaluation parameters include one or more parameter values associated with a characteristic of a type of cell selection that is to be performed. The cell selection component 708 may perform the type of cell selection in accordance with the set of network slice specific cell selection evaluation parameters.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a base station, or a base station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150. The communication manager 150 may include a cell selection configuration component 808, among other examples.

In some aspects, the apparatus 800 may be configured to perform one or more operations described herein in connection with FIGS. 4A-4E. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the base station described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station described in connection with FIG. 2. In some aspects, the transmission component 804 may be co-located with the reception component 802 in a transceiver.

The transmission component 804 may transmit, to a UE, information identifying a set of network slice specific cell selection evaluation parameters, wherein the set of network slice specific cell selection evaluation parameters include one or more parameter values associated with a characteristic of a type of cell selection that is to be performed. The reception component 802 and/or transmission component 804 may communicate with the UE on a cell selected in accordance with a cell selection and the set of network slice specific cell selection evaluation parameters. The cell selection configuration component 808 may configure network slice specific cell selection evaluation parameters for the apparatus 806.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a user equipment (UE), comprising: receiving information identifying a set of network slice specific cell selection evaluation parameters, wherein the set of network slice specific cell selection evaluation parameters include one or more parameter values associated with a characteristic of a type of cell selection that is to be performed; and performing the type of cell selection in accordance with the set of network slice specific cell selection evaluation parameters.
Aspect 2: The method of Aspect 1, wherein the cell selection is a cell reselection type of cell selection procedure or a non-cell reselection type of cell selection procedure.
Aspect 3: The method of any of Aspects 1 to 2, wherein the set of network slice specific cell selection evaluation parameters includes a parameter relating to at least one of: an intra-frequency reselection, an inter-frequency reselection, an intra-radio-access-technology (RAT) reselection, an inter-RAT reselection, or a cell priority.
Aspect 4: The method of any of Aspects 1 to 3, wherein the set of network slice specific cell selection evaluation parameters includes a value for at least one of a network slice offset or a network slice threshold.
Aspect 5: The method of any of Aspects 1 to 4, wherein the set of network slice specific cell selection evaluation parameters relate to a network slice associated with at least one of: a network slice selection assistance information identifier, a single network slice selection assistance information identifier, a single network slice selection assistance information identifier group, or a slice or service type identifier.
Aspect 6: The method of any of Aspects 1 to 5, wherein the information identifying the set of network slice specific cell selection evaluation parameters is received via a dedicated radio resource control message, a system information block message, or a subscription establishment message.
Aspect 7: The method of any of Aspects 1 to 5, wherein the information identifying the set of network slice specific cell selection evaluation parameters is received from a memory.
Aspect 8: The method of any of Aspects 1 to 7, wherein the cell selection is based at least in part on a network slice to which the set of network slice specific cell selection evaluation parameters applies.
Aspect 9: The method of any of Aspects 1 to 8, wherein the set of network slice specific cell selection evaluation parameters includes a plurality of subsets of parameters applicable to a plurality of different types of use cases.
Aspect 10: The method of any of Aspects 1 to 9, wherein the cell selection includes an evaluation of one or more slices.
Aspect 11: The method of any of Aspects 1 to 10, wherein the cell selection includes an evaluation of a slice priority of a plurality of slices associated with a particular frequency.
Aspect 12: The method of any of Aspects 1 to 11, wherein the cell selection is initiated based at least in part on an evaluation of a criterion relating to initiating a call connection.
Aspect 13: A method of wireless communication performed by a base station, comprising: transmitting, to a UE, information identifying a set of network slice specific cell selection evaluation parameters, wherein the set of network slice specific cell selection evaluation parameters include one or more parameter values associated with a characteristic of a type of cell selection that is to be performed; and communicating with the UE on a cell selected in accordance with a cell selection and the set of network slice specific cell selection evaluation parameters.
Aspect 14: The method of Aspect 13, wherein the cell selection is a cell reselection type of cell selection procedure or a non-cell reselection type of cell selection procedure.
Aspect 15: The method of any of Aspects 13 to 14, wherein the set of network slice specific cell selection evaluation parameters includes a parameter relating to at least one of: an intra-frequency reselection, an inter-frequency reselection, an intra-radio-access-technology (RAT) reselection, an inter-RAT reselection, or a cell priority.
Aspect 16: The method of any of Aspects 13 to 15, wherein the set of network slice specific cell selection evaluation parameters includes a value for at least one of a network slice offset or a network slice threshold.
Aspect 17: The method of any of Aspects 13 to 16, wherein the set of network slice specific cell selection evaluation parameters relate to a network slice associated with at least one of: a network slice selection assistance information identifier, a single network slice selection assistance information identifier, a single network slice selection assistance information identifier group, or a slice or service type identifier.
Aspect 18: The method of any of Aspects 13 to 17, wherein the information identifying the set of network slice specific cell selection evaluation parameters is transmitted via a dedicated radio resource control message, a system information block message, or a subscription establishment message.
Aspect 19: The method of any of Aspects 13 to 18, wherein the cell selection is based at least in part on a network slice to which the set of network slice specific cell selection evaluation parameters applies.
Aspect 20: The method of any of Aspects 13 to 19, wherein the set of network slice specific cell selection evaluation parameters includes a plurality of subsets of parameters applicable to a plurality of different types of use cases.
Aspect 21: The method of any of Aspects 13 to 20, wherein the cell selection includes an evaluation of one or more slices.
Aspect 22: The method of any of Aspects 13 to 21, wherein the cell selection includes an evaluation of a slice priority of a plurality of slices associated with a particular frequency.
Aspect 23: The method of any of Aspects 13 to 22, wherein the cell selection is initiated based at least in part on an evaluation of a criterion relating to initiating a call connection.
Aspect 24: An apparatus for wireless communication at a device, comprising a processor; memory coupled with the processor; and instructions stored in the memory and executable by the processor to cause the apparatus to perform the method of one or more of Aspects 1-12.
Aspect 25: A device for wireless communication, comprising a memory and one or more processors coupled to the memory, the one or more processors configured to perform the method of one or more of Aspects 1-12.
Aspect 26: An apparatus for wireless communication, comprising at least one means for performing the method of one or more of Aspects 1-12.
Aspect 27: A non-transitory computer-readable medium storing code for wireless communication, the code comprising instructions executable by a processor to perform the method of one or more of Aspects 1-12.
Aspect 28: A non-transitory computer-readable medium storing a set of instructions for wireless communication, the set of instructions comprising one or more instructions that, when executed by one or more processors of a device, cause the device to perform the method of one or more of Aspects 1-12.
Aspect 29: An apparatus for wireless communication at a device, comprising a processor; memory coupled with the processor; and instructions stored in the memory and executable by the processor to cause the apparatus to perform the method of one or more of Aspects 13-23.
Aspect 30: A device for wireless communication, comprising a memory and one or more processors coupled to the memory, the one or more processors configured to perform the method of one or more of Aspects 13-23.
Aspect 31: An apparatus for wireless communication, comprising at least one means for performing the method of one or more of Aspects 13-23.
Aspect 32: A non-transitory computer-readable medium storing code for wireless communication, the code comprising instructions executable by a processor to perform the method of one or more of Aspects 13-23.
Aspect 33: A non-transitory computer-readable medium storing a set of instructions for wireless communication, the set of instructions comprising one or more instructions that, when executed by one or more processors of a device, cause the device to perform the method of one or more of Aspects 13-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive information identifying a set of network slice specific cell selection evaluation parameters, wherein the set of network slice specific cell selection evaluation parameters include one or more parameter values associated with a characteristic of a type of cell selection that is to be performed; and
perform the type of cell selection in accordance with the set of network slice specific cell selection evaluation parameters.

2. The UE of claim 1, wherein the cell selection is a cell reselection type of cell selection procedure or a non-cell reselection type of cell selection procedure.

3. The UE of claim 1, wherein the set of network slice specific cell selection evaluation parameters includes a parameter relating to at least one of:
an intra-frequency reselection,
an inter-frequency reselection,
an intra-radio-access-technology (RAT) reselection,
an inter-RAT reselection, or
a cell priority.

4. The UE of claim 1, wherein the set of network slice specific cell selection evaluation parameters includes a value for at least one of a network slice offset or a network slice threshold.

5. The UE of claim 1, wherein the set of network slice specific cell selection evaluation parameters relate to a network slice associated with at least one of:
a network slice selection assistance information identifier,
a single network slice selection assistance information identifier,
a single network slice selection assistance information identifier group, or
a slice or service type identifier.

6. The UE of claim 1, wherein the information identifying the set of network slice specific cell selection evaluation parameters is received via a dedicated radio resource control message, a system information block message, or a subscription establishment message.

7. The UE of claim 1, wherein the information identifying the set of network slice specific cell selection evaluation parameters is received from a memory.

8. The UE of claim 1, wherein the cell selection is based at least in part on a network slice to which the set of network slice specific cell selection evaluation parameters applies.

9. The UE of claim 1, wherein the set of network slice specific cell selection evaluation parameters includes a plurality of subsets of parameters applicable to a plurality of different types of use cases.

10. The UE of claim 1, wherein the cell selection includes an evaluation of one or more slices.

11. The UE of claim 1, wherein the cell selection includes an evaluation of a slice priority of a plurality of slices associated with a particular frequency.

12. The UE of claim 1, wherein the cell selection is initiated based at least in part on an evaluation of a criterion relating to initiating a call connection.

13. A base station for wireless communication, comprising:
a memory; and
one or more processors, coupled to the memory, configured to:
transmit, to a user equipment (UE), information identifying a set of network slice specific cell selection evaluation parameters, wherein the set of network slice specific cell selection evaluation parameters include one or more parameter values associated with a characteristic of a type of cell selection that is to be performed; and
communicate with the UE on a cell selected in accordance with a cell selection and the set of network slice specific cell selection evaluation parameters.

14. The base station of claim 13, wherein the cell selection is a cell reselection type of cell selection procedure or a non-cell reselection type of cell selection procedure.

15. The base station of claim 13, wherein the set of network slice specific cell selection evaluation parameters includes a parameter relating to at least one of:
an intra-frequency reselection,
an inter-frequency reselection,
an intra-radio-access-technology (RAT) reselection,
an inter-RAT reselection, or
a cell priority.

16. The base station of claim 13, wherein the set of network slice specific cell selection evaluation parameters includes a value for at least one of a network slice offset or a network slice threshold.

17. The base station of claim 13, wherein the set of network slice specific cell selection evaluation parameters relate to a network slice associated with at least one of:
a network slice selection assistance information identifier,
a single network slice selection assistance information identifier,
a single network slice selection assistance information identifier group, or
a slice or service type identifier.

18. The base station of claim 13, wherein the information identifying the set of network slice specific cell selection evaluation parameters is transmitted via a dedicated radio resource control message, a system information block message, or a subscription establishment message.

19. The base station of claim 13, wherein the cell selection is based at least in part on a network slice to which the set of network slice specific cell selection evaluation parameters applies.

20. The base station of claim 13, wherein the set of network slice specific cell selection evaluation parameters includes a plurality of subsets of parameters applicable to a plurality of different types of use cases.

21. The base station of claim 13, wherein the cell selection includes an evaluation of one or more slices.

22. The base station of claim 13, wherein the cell selection includes an evaluation of a slice priority of a plurality of slices associated with a particular frequency.

23. The base station of claim 13, wherein the cell selection is initiated based at least in part on an evaluation of a criterion relating to initiating a call connection.

24. A method of wireless communication performed by a user equipment (UE), comprising:
receiving information identifying a set of network slice specific cell selection evaluation parameters, wherein the set of network slice specific cell selection evaluation parameters include one or more parameter values associated with a characteristic of a type of cell selection that is to be performed; and
performing the type of cell selection in accordance with the set of network slice specific cell selection evaluation parameters.

25. The method of claim 24, wherein the cell selection is a cell reselection type of cell selection procedure or a non-cell reselection type of cell selection procedure.

26. The method of claim 24, wherein the set of network slice specific cell selection evaluation parameters includes a parameter relating to at least one of:
an intra-frequency reselection,
an inter-frequency reselection,
an intra-radio-access-technology (RAT) reselection,
an inter-RAT reselection, or
a cell priority.

27. A method of wireless communication performed by a base station, comprising:
transmitting, to a user equipment (UE), information identifying a set of network slice specific cell selection evaluation parameters, wherein the set of network slice specific cell selection evaluation parameters include one or more parameter values associated with a characteristic of a type of cell selection that is to be performed; and
communicating with the UE on a cell selected in accordance with a cell selection and the set of network slice specific cell selection evaluation parameters.

28. The method of claim 27, wherein the cell selection is a cell reselection type of cell selection procedure or a non-cell reselection type of cell selection procedure.

29. The method of claim 27, wherein the set of network slice specific cell selection evaluation parameters includes a parameter relating to at least one of:
an intra-frequency reselection,
an inter-frequency reselection,
an intra-radio-access-technology (RAT) reselection,
an inter-RAT reselection, or
a cell priority.

30. The method of claim 27, wherein the set of network slice specific cell selection evaluation parameters includes a value for at least one of a network slice offset or a network slice threshold.
